(19) United States
(12) Patent Application Publication
(10) Pub. No.: US 2014/0006996 A1
(43) Pub. Date: Jan. 2, 2014

(54) VISUAL PROXIMITY KEYBOARD

(71) Applicant: Apolon Ivankovic, Wangara (AU)

(72) Inventor: Apolon Ivankovic, Wangara (AU)

(21) Appl. No.: 13/985,011

(22) PCT Filed: Feb. 10, 2012
(86) PCT No.: PCT/AU12/00122

§ 371 Date: Sep. 17, 2013

(30) Foreign Application Priority Data
Feb. 13, 2011 (AU) 2011900465

(51) Int. Cl. G06F 3/0488

(52) U.S. Cl. CPC G06F 3/04886
USPC 715/773

(57) ABSTRACT

An interface system for facilitating human interfacing with a computing device is provided. The interface system comprises an input device arranged to detect touch based inputs made by an object and to communicate the detected inputs to the computing device. The interface system also comprises a position detection system arranged to obtain positional information indicative of a position of the object relative to the input device. The interface system is arranged to use the positional information to facilitate display of visual information on a display of the computing device, the visual information being indicative of a position of the object relative to the input device so as to assist a user in operation of the input device.

### FIELD OF THE INVENTION

The present invention relates to an interface system for a computing device and a method of interfacing with a computing device.

### BACKGROUND OF THE INVENTION

Computer input devices, such as keyboards, can be difficult to use in certain circumstances. For example, if a user cannot, or finds it difficult to, look at the input device when inputting information then the user may find it difficult to enter the information correctly.

Such a situation may arise if the user is incapacitated and is required to lie flat on their back. If the user is in such a situation, the user may be able to view a computer display, but may not be able to view the input device without significant head movement. This type of head movement may be difficult and/or inadvisable for the incapacitated user. As such, the user may not be able to see how their hands are oriented with respect to the input device, making inputting of information difficult.

As such there is a need for technological advancement.

### SUMMARY OF THE INVENTION

In accordance with a first aspect of the present invention, there is provided an interface system for facilitating human interfacing with a computing device, the interface system comprising:
an input device arranged to detect touch based inputs made by an object and to communicate the detected inputs to the computing device; and
a position detection system arranged to obtain positional information indicative of a position of the object relative to the input device;
wherein the interface system is arranged to use the positional information to facilitate display of visual information on a display of the computing device, the visual information being indicative of a position of the object relative to the input device so as to assist a user in operation of the input device.

The interface system may be arranged so as to facilitate display of visual information on the computing device display indicative of an input layout of the input device and the position of the object relative to the input layout.

The interface system may be arranged to facilitate display of a representation of the object relative to the input layout of the input device.

The representation of the object may indicate a distance between at least a portion of the object and the input layout of the input device. In one embodiment, the indication of the distance between the at least a portion of the object and the input layout is represented as colour or shading information.

Further, or alternatively, the indication of the distance between the at least a portion of the object and the input layout is provided by altering a transparency level of a portion of the representation corresponding to the at least a portion of object. The interface system may be arranged such that the displayed representation of the at least a portion of the object becomes more transparent the further away it is from the input layout.

In one embodiment, the interface system is arranged such that a representation of at least a portion of the object is not displayed if a distance between the at least a portion of the object and the input layout is greater than a predetermined threshold.

The interface system may be arranged to facilitate visual representation on the computing device display of a touch event, the touch event corresponding to when the object touches the input device. The touch event may be represented by highlighting an area of a representation of the input device that corresponds to a location of the touch event.

In one embodiment, the input device comprises a touch screen interface. The input device may be arranged to enable an input layout of the touch screen interface to be altered, wherein the interface system is arranged to facilitate display of the altered input layout on the computing device display.

The input device may comprise separate first and second input device portions. The first and second input device portions may be couplable together in a releasably engagable configuration. In embodiments wherein the input device comprises separate first and second input device portions, the interface system may be arranged to facilitate display of visual information on the computing device display indicative of an input layout of each of the first and second input device portions.

The system may be arranged to facilitate displaying the representations of the layouts of the first and second input device portions on the computing device display separately.

In one embodiment, the interface system is arranged to prevent display of the visual information when a trigger condition exists. The trigger condition may correspond to entering sensitive information.

In one embodiment, the interface system is arranged to receive orientation information indicative of an orientation of virtual or augmented reality glasses and to use the orientation information to determine when to display the visual information. The system may be arranged to display the visual information when the received orientation information is indicative of a downwards tilt of the virtual or augmented reality glasses.

In accordance with a second aspect of the present invention, there is provided a method of interfacing with a computing device comprising the steps of:
obtaining positional information indicative of a position of an object relative to an input device, the input device being arranged to detect touch based inputs made by an object and to communicate the detected inputs to the computing device; and
facilitating display of visual information on a display of the computing device, the visual information being indicative of a position of the object relative to the input device so as to assist a user in operation of the input device.

In accordance with a third aspect of the present invention, there is provided a computer program arranged when loaded into a computing device to instruct the computing device to operate in accordance with the system of the first aspect of the present invention.

In accordance with a fourth aspect of the present invention, there is provided a computer readable medium having a computer readable program code embodied therein for causing a computing device to operate in accordance with the system of the first aspect of the present invention.

In accordance with a fifth aspect of the present invention, there is provided a data signal having a computer readable program code embodied therein to cause a computing device to operate in accordance with the system of the first aspect of the present invention.

### BRIEF DESCRIPTION OF THE DRAWINGS

In order that the present invention may be more clearly ascertained, embodiments of the present invention will now be described, by way of example only, with reference to the accompanying drawings, in which:

FIG. 1 is a schematic diagram of an interface system in accordance with an embodiment of the present invention;

FIG. 2 is an example screen shot of visual information that is displayed on a display of a computing device, the display of the visual information being facilitated by the interface system of FIG. 1;

FIG. 3a is a top view of an input device of the interface system of FIG. 1, the input device being shown in a coupled configuration;

FIG. 3b is a top view of the input device of FIG. 3a, the input device being shown in a split configuration; and

FIG. 4 is a flow diagram of a method of interfacing with a computing device in accordance with an embodiment of the present invention.

### DETAILED DESCRIPTION OF THE EMBODIMENTS

In general, there is provided an interface system for facilitating human interfacing with a computing device, and a method of interfacing with a computing device.

The interface system comprises a touch based input device, for example a keyboard, arranged to detect touch based inputs. The touch based input device may, for example, be a conventional type keyboard having physical keys and that detects keystrokes as the keys are depressed by a user. Alternatively, the touch based input device may be a touch screen based keyboard, for example a touch screen that is arranged to display an input layout and that detects when a user touches parts of the screen corresponding to inputs of the input layout.

In addition to providing a touch based input device, the interface system is arranged to detect a position of an object relative to the touch based input device. Since a user typically uses their hands to enter information via the touch based input device, the user's hands will typically be the object detected by the interface system. The relative position of the user's hands with respect to the touch based input device can then be visually represented, for example on a display of the computing device, so as to assist the user in using the touch based input device.

Visually representing the relative position of the user's hands with respect to the touch based input device provides visual feedback to the user indicating where their hands are in relation to the touch based input device. The user can use this visual feedback to arrange their finger's over the keys they desire to touch so as to enter desired information. This can be of particular advantage when the user cannot, or finds it difficult to, look at the input device when inputting information but is able to view the display of the computing device.

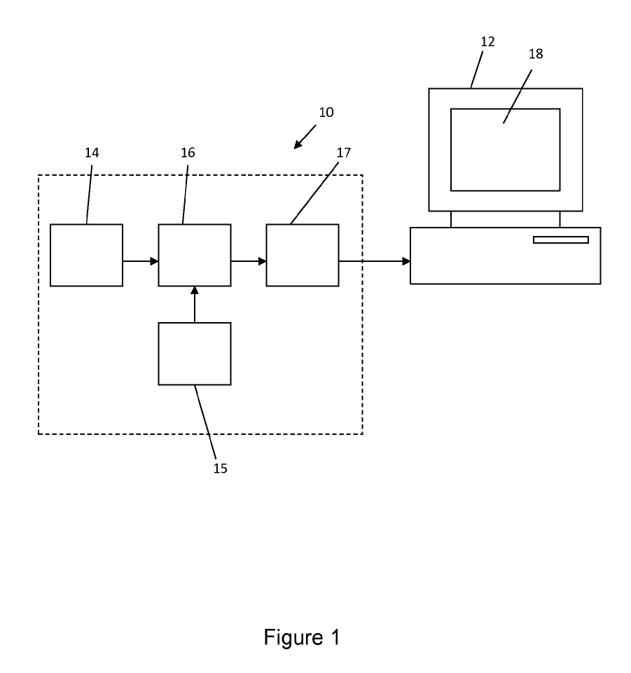

A specific example of an interface system 10 will now be described with reference to FIG. 1. The interface system 10 is arranged so as to facilitate human interfacing with a computing device 12 and comprises a touch based input device 14 arranged to detect touch based inputs made by an object, such as a user's hand. The interface system 10 also comprises a position detection system 15 arranged to obtain positional information indicative of a position of the object relative to the input device 14. The input device 14 and position detection system 15 respectively communicate the touch based input and the positional information to a processor 16 of the interface system 10.

The processor 16 is arranged to receive the touch based input and positional information and to process this information so as to provide visual information that is indicative of a position of the object relative to the input device 14 so as to assist the user in operation of the input device 14. The processor 16 is also arranged to provide visual information that is indicative of the input layout of the input device 14 based on input layout information received from the input device 14. To allow the processor 16 to provide the visual information, the interface system 10 is provided with a memory device (not shown) that is accessible by the processor 16 and that is arranged for storing an appropriate program usable by the processor 16 to perform the necessary processing to provide the visual information.

The visual information is then communicated to a communications device 17 for subsequent communication to the computing device 12. In this example, the communications device 17 is a wireless communications device that utilises an appropriate wireless protocol such as Bluetooth so as to communicate the visual information to the computing device 12 wirelessly. The computing device 12 is arranged to wirelessly receive the visual information communicated from the communications device 17 and to display the visual information on a display 18 of the computing device 12.

Although in the above example the interface system 10 is described as comprising a processor 16 that is arranged to provide the visual information, it will be appreciated that appropriate software can be installed on the computing device 12 so as to allow a processor of the computing device 12 to perform a similar function. In such an arrangement, the input device 14 and the position detection system 15 may communicate touch based inputs and positional information, either by a wired or wireless connection, to the computing device 12 wherein the visual information is provided by the processor of the computing device 12 and then displayed on the display 18.

In the example shown in FIG. 1, the interface system 10 is a touch screen based input device that is arranged to provide touch based inputs received from the user via a touch screen, and wherein the position of the user's hands is detected by an infrared sensing system. Examples of touch screen input devices that utilise both touch screen based inputs and object position detection include 3D proximity sensing touch screens manufactured by Mitsubishi Electric Corporation, Cypress Semiconductor Corporation's Hover Detection for TrueTouch touch screens, and the PixelSense technology used in Microsoft Corporation's Surface 2.0 device.

The touch screen based input device is also arranged to provide haptic feedback to the user. For example, the touch screen based input device can be arranged so as to provide the user with physical feedback coinciding with when the user inputs information, analogous to feedback a user would feel when inputting information via a traditional keyboard.

Although a device that offers both touch based input detection and object position detection can be used, it will be appreciated that these functions can be provided by separate devices, and it will be appreciated that any appropriate technologies that are able to provide these functions can be used. For example, the touch based input detection can be provided by capacitive touch sensing or resistive touch sensing technologies, and the object position detection can be provided by an infra red based position detection system or a capacitive position detection system. It will be appreciated that capacitive sensing technology can be used for both touch and position detection.

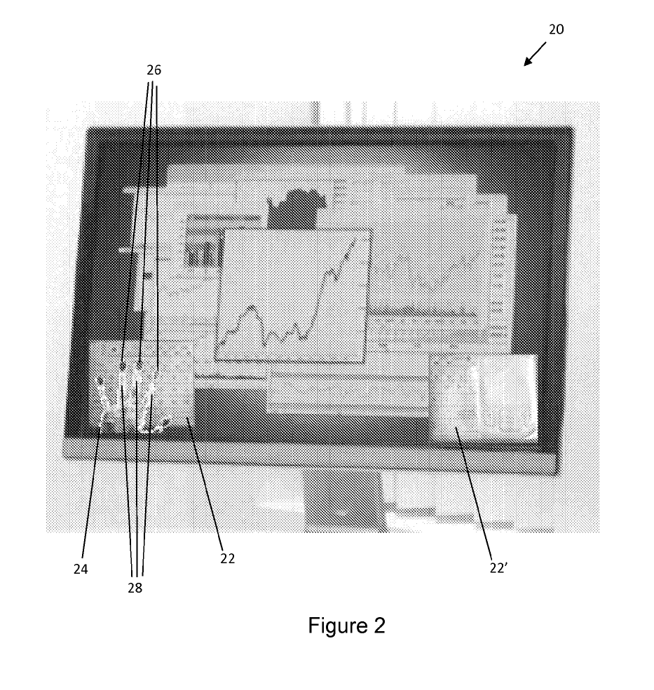

An example screen shot 20 from the computing device display 18 is shown in FIG. 2. The screen shot 20 shows a representation 22 of an input layout of the touch based input device 14, and a representation 24 of the user's hand in accordance with the visual information provided by the interface system 10. When the user moves their hand, the position detection system 15 will detect the new position of the user's hand, and the representation 24 of the user's hand will be updated accordingly. In this way, the user is provided with substantially real time feedback regarding the position of the user's hand relative to the input layout of the input device 14.

The representation 24 of the user's hand also indicates how far parts of the hand are from the input layout of the input device 14. In this example, the further away a part of the user's hand, the lighter the shading used in a corresponding portion of the representation 24. For example, portions 26 of the representation 24 corresponding to finger tips of the user are shaded darker than portions 28 of the representation 24 corresponding to intermediate finger portions, indicating that the finger tips are closer to the input layout of the input device 14 than the intermediate finger portions. Although shading is used in this example to provide an indication of how far parts of the user's hand are from the input layout of the input device 14, it will be appreciated that colours could be used for a similar purpose wherein different colours correspond to different distances from the input device 14.

Further, or alternatively, a transparency level of the representation 24 can be altered to provide the user with feedback as to the distance the user's hand is from the input device 14. In particular, the interface system 10 can be arranged to cause the representation 24 to become more transparent the further the user's hand is from the input device 14, and wherein when the user's hand is a predefined distance from the input device 14, the representation 24 is not displayed. The predefined distance may be in the order of centimetres, such as 5 cm. In one example, the predefined distance is substantially a distance that a user's finger can reach when bent away from the palm.

It will be appreciated that, even if the interface system 10 is not arranged to alter the transparency level of the representation 24, the interface system 10 may still be arranged to no longer display the representation 24 when the user's hand is beyond the predefined distance from the input device 14.

When the user touches the input device 14, the interface system 10 is arranged to provide a corresponding visual indication. For example, an area of the representation 22 of the input device 14 corresponding to an area of the input device 14 that was touched can be highlighted at the time the touch occurs.

In this example, the input device 14 is arranged to enable an input layout of its touch screen interface to be altered and is particularly arranged to change dynamically based on current user interface input needs. For example, if the user is entering information into a field that requires only numbers, the touch screen interface of the input device is arranged to only display numbers, and to display the full standard alphanumeric keyboard face at other times. To cater for this, the interface system 10 is arranged to facilitate display of the altered input layout on the computing device display 18.

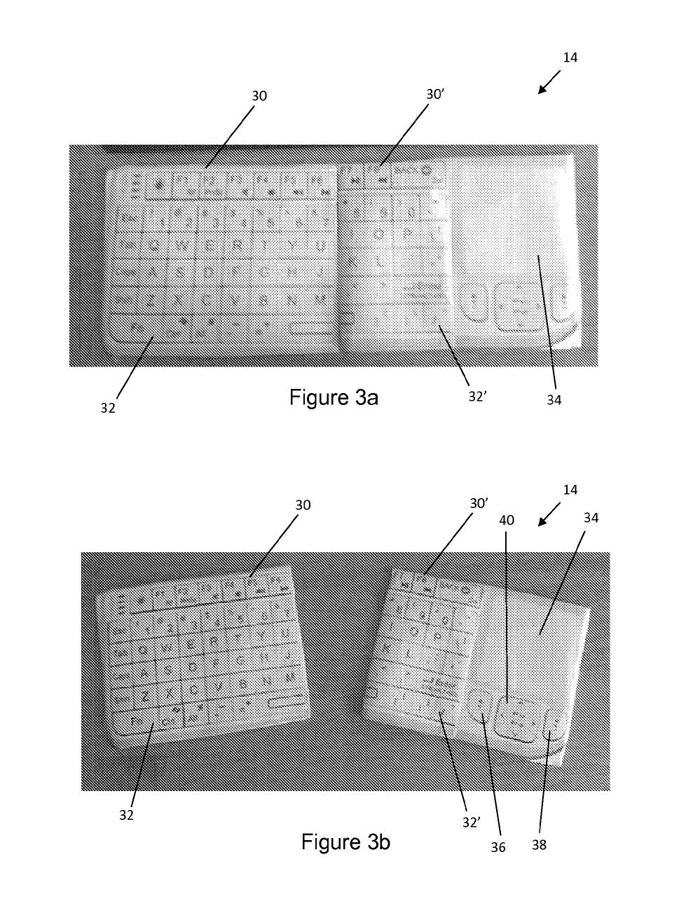

In this example, and referring now to FIGS. 3a and 3b, the input device 14 comprises separate first and second input device portions 30, 30′. The first and second input device portions 30, 30′ are releasably engagable with one another so as to allow the input device portions 30, 30′ to be either joined together so as to function as a typical keyboard (see FIG. 3a showing the input device portions 30, 30′ in a coupled configuration), or to be separated so as to function as a split keyboard (see FIG. 3b showing the input device portions 30, 30′ in a split configuration).

Each input device portion 30, 30′ has a respective input layout 32, 32′. In this example, the input layout 32 of the first input device portion 30 substantially corresponds to an input layout that would typically be found on a left-hand side of a standard keyboard, and the input layout 32′ of the second input device portion 30′ substantially corresponds to an input layout that would typically be found on a right-hand side of a standard keyboard. In this example, the input layout 32′ of the second input device portion 30′ includes a trackpad portion 34 for enabling a user to move a pointer or similar displayed on the display 18, ‘left’ and ‘right’ buttons 36, 38 corresponding to the functions of left and right mouse buttons, and a navigation button array 40 for enabling the user to perform such functions as scrolling.

The interface system 10 is arranged to display the input layout of each of the first and second input device portions 30, 30′ on the computing device display 18 as respective representations 22, 22′ as shown in FIG. 2.

The interface system 10 is also arranged to prevent display of the visual information on the computing device display 18 under certain circumstances, such as when the user is entering sensitive information. This may be triggered automatically, such as when the interface system 10 detects that a password or the like is required to be entered, or it may be triggered manually in response to the user pressing an appropriate function button or issuing an appropriate command.

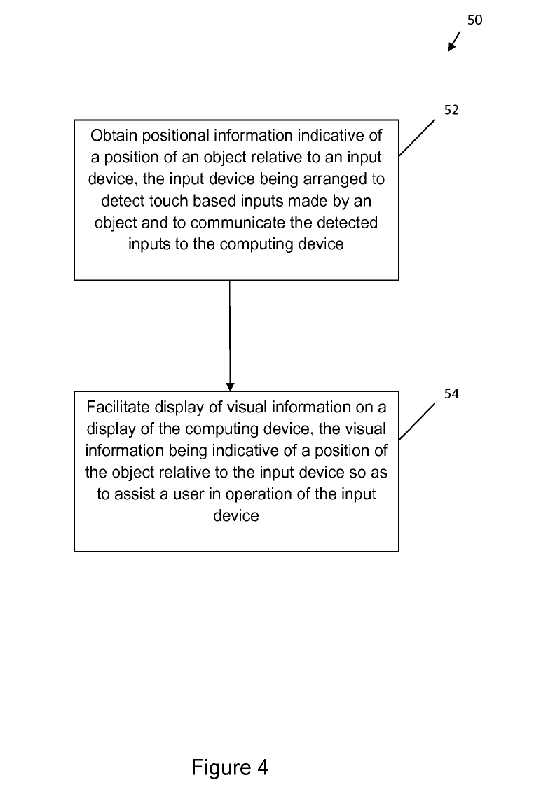

A method 50 of interfacing with a computing device, such as computing device 12, is now described with reference to FIG. 4. In a first step 52, the method 50 comprises obtaining positional information indicative of a position of an object relative to the input device 14. The input device 14, as described earlier, is arranged to detect touch based inputs made by an object and to communicate the detected inputs to the computing device 12.

In a second step 54, the method comprises facilitating display of visual information on the display 18 of the computing device 12, wherein the visual information is indicative of a position of the object relative to the input device 14 so as to assist a user in operation of the input device 14.

The method 50 can be carried out using the interface system 10 described herein.

The interface system 10 can be used for different applications. For example, the input device 14 can be arranged in the split configuration wherein the first input device portion 30 is mounted on a left arm of a chair and the second input device portion 30′ is mounted on a right arm of a chair. In this way, repetitive stress problems associated with typical keyboard use wherein a user places their hands out in front of them can be avoided as the user can instead rest their arms on the left and right arms of the chair. The user is still able to enter information via the input device 14 since they are provided with visual feedback on the display 18 as to the relative position of their hands with respect to the input device 14. The user is not required to look down to orient their hands with respect to the first and second input device portions 30, 30′.

The interface system 10 can also be used to more conveniently utilise large displays, for example when a presenter is giving a presentation on a large screen in an auditorium. Since visual feedback is provided to the presenter as to the position of his hands relative to the input device 14, the presenter need not take his attention away from the display to orient his hands with respect to the input device 14. The visual feedback will also be provided to the audience, thereby providing the audience with additional information regarding information the presenter may be inputting during the presentation.

Further, a plurality of input devices 14 can be provided so as to allow multiple users to collaboratively work on the same application. For example, the first and second input device portions 30, 30′ can be separated and arranged to each provide a complete keyboard layout and trackpad. The first and second input portions 30, 30′ can then be provided to different users to enable the collaborative work.

In another application, the interface system 10 can be used to assist incapacitated users. For example, if a user is incapacitated and is required to lie flat on their back for long periods of time, the first and second input device portions 30, 30′ can be placed on respective sides of the user's body next to each hand. This can enable the user to input information via the input device 14 with minimal arm movements and in the prone position.

In a further application, virtual reality or augmented reality glasses can be used in place of the display 18 of the computing device 12. As these types of glasses take up a large portion, often the entirety, of the user's field of view, the interface system 10 can be used to enable the user to input information via the input device 14 without the need to remove the glasses since the visual feedback is provided via the glasses.

In one particular example of a virtual reality application, virtual reality glasses are provided with orientation sensors, for example sensors based on accelerometer technology, so as to allow an orientation of the glasses to be determined. The orientation of the glasses is communicated as orientation information to the interface system 10, such as via a Bluetooth connection, and the interface system 10 is arranged to use the orientation information to determine when to display a representation 22 of an input layout of the touch based input device 14, and a representation 24 of the user's hand.

For example, when the user's head is positioned so as to be looking straight ahead with respect to the orientation of the user's body, the interface system 10 is arranged to not display the representations 22, 24. Instead, the user is presented with a full view of their virtual reality environment. When the user looks down, such as with a slight tilt of the head, the change in orientation of the glasses is detected by the orientation sensors and the respective orientation information is communicated to the interface system 10. In response to receiving the orientation information, the interface system 10 is arranged to display the representations 22, 24. The representations 22, 24 can, for example, be shown in a location of the virtual reality environment that would correspond to a position of the input device 14 relative to the user in the real world.

In a still further application, if a user's view incorporates a heads up display (HUD), the interface system 10 can be arranged to provide visual feedback regarding the position of the user's hands with respect to the input device 14 via the HUD. This can enable the user to concentrate on the view and the HUD while still inputting information via the input device 14.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

For example, it is envisaged that a mobile device such as a mobile telephone can be used as the input device 14. In particular, a programmable mobile device that has a touch screen input and that is able to provide position detection of objects relative to the touch screen can be used as an input device. Multiple users can then collaborate on a single display using their respective mobile devices. In such a scenario, the interface system 10 can be arranged to indicate on the display which mobile device is inputting what information and/or visually indicate which mobile device currently has priority to enter information.

Further, it is envisaged that the system 10 or method 50 may be implemented as a computer program that is arranged, when loaded into a computing device, to instruct the computing device to operate in accordance with the system 10 or method 50.

Further, or alternatively, the system 10 or method 50 may be provided in the form of a computer readable medium having a computer readable program code embodied therein for causing a computing device to operate in accordance with the system 10 or method 50.

Still further, or alternatively, the system 10 or method 50 may be provided in the form of a data signal having a computer readable program code embodied therein to cause a computing device to operate in accordance with the system 10 or method 50.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-40. (canceled)

41. An interface system for facilitating human interfacing with a computing device, the interface system comprising:
an input device arranged to detect touch based inputs made by an object and to communicate the detected inputs to the computing device; and
a position detection system arranged to obtain positional information indicative of a position of the object relative to the input device;
wherein the interface system is arranged to use the positional information to facilitate display of visual information on a display of the computing device, the display being spaced from the input device and the visual information being indicative of a position of the object relative to the input device so as to assist a user in operation of the input device.

42. The interface system of claim 41, wherein the interface system is arranged to facilitate display of visual information on the computing device display indicative of an input layout of the input device and the position of the object relative to the input layout.

43. The interface system of claim 42, wherein the interface system is arranged to facilitate display of a representation of the object relative to the input layout of the input device.

44. The interface system of claim 43, wherein the representation of the object indicates a distance between at least a portion of the object and the input layout of the input device.

45. The interface system of claim 44, wherein the indication of the distance between the at least a portion of the object and the input layout is represented as colour or shading information.

46. The interface system of claim 44, wherein the indication of the distance between the at least a portion of the object and the input layout is provided by altering a transparency level of a portion of the representation corresponding to the at least a portion of object.

47. The interface system of claim 46, wherein the representation of the at least a portion of the object becomes more transparent the further away it is from the input layout.

48. The interface system of claim 43, wherein the interface system is arranged such that a representation of at least a portion of the object is not displayed if a distance between the at least a portion of the object and the input layout is greater than a predetermined threshold.

49. The interface system of claim 41, wherein the interface system is arranged to facilitate visual representation on the computing device display of a touch event, the touch event corresponding to when the object touches the input device.

50. The interface system of claim 41, wherein the input device comprises a touch screen interface.

51. The interface system of claim 50, wherein the input device is arranged to enable an input layout of the touch screen interface to be altered, wherein the interface system is arranged to facilitate display of the altered input layout on the computing device display.

52. The interface system of claim 41, wherein the system is arranged to receive orientation information indicative of an orientation of virtual or augmented reality glasses and to use the orientation information to determine when to display the visual information.

53. The interface system of claim 52, wherein the system is arranged to display the visual information when the received orientation information is indicative of a downwards tilt of the virtual or augmented reality glasses.

54. A method of interfacing with a computing device comprising the steps of:
obtaining positional information indicative of a position of an object relative to an input device, the input device being arranged to detect touch based inputs made by an object and to communicate the detected inputs to the computing device; and
facilitating display of visual information on a display of the computing device, the display being spaced from the input device and the visual information being indicative of a position of the object relative to the input device so as to assist a user in operation of the input device.

55. The method of claim 54, wherein the visual information is indicative of an input layout of the input device and the position of the object relative to the input layout.

56. The method of claim 55, comprising the step of facilitating display of a representation of the object relative to the input layout of the input device.

57. The method of claim 56, wherein the representation of the object indicates a distance between at least a portion of the object and the input layout of the input device.

58. The method of claim 57, wherein the indication of the distance between the at least a portion of the object and the input layout is represented as colour or shading information.

59. The method of claim 57, wherein the indication of the distance between the at least a portion of the object and the input layout is provided by altering a transparency level of a portion of the representation corresponding to the at least a portion of object.

60. The method of claim 59, wherein the representation of the at least a portion of the object becomes more transparent the further away it is from the input layout.

61. The method of claim 56, wherein the representation of at least a portion of the object is not displayed if a distance between the at least a portion of the object and the input layout is greater than a predetermined threshold.

62. The method of claim 54, further comprising the step of facilitating visual representation on the computing device display of a touch event, the touch event corresponding to when the object touches the input device.

63. The method of claim 54, further comprising the steps of:
altering an input layout of the input device; and
facilitating display of the altered input layout on the computing device display.

64. The method of claim 54, wherein the method comprises the steps of:
receiving orientation information indicative of an orientation of virtual or augmented reality glasses; and
determining when to display the visual information based on the received orientation information.

65. The method of claim 64, comprising the step of:
displaying the visual information when the received orientation information is indicative of a downwards tilt of the virtual or augmented reality glasses.

66. A computer program arranged when loaded into a computing device to instruct the computing device to operate in accordance with the system of claim 41.

67. A computer readable medium having a computer readable program code embodied therein for causing a computing device to operate in accordance with the system of claim 41.

68. A data signal having a computer readable program code embodied therein to cause a computing device to operate in accordance with the system of claim 41.
